(19) United States
(12) Patent Application Publication
(10) Pub. No.: US 2015/0072218 A1
(43) Pub. Date: Mar. 12, 2015

(54) BATTERY PACK AND BATTERY MODULE INCLUDING THE SAME

(71) Applicant: SAMSUNG SDI CO., LTD., Yongin-si (KR)

(72) Inventors: Jeong-Doo Yi, Yongin-si (KR); Bong-Kyoung Park, Yongin-si (KR); Hye-Jung Lee, Yongin-si (KR); Feygenson Naum, Yongin-si (KR)

(21) Appl. No.: 14/335,039

(22) Filed: Jul. 18, 2014

(30) Foreign Application Priority Data
Sep. 9, 2013 (KR) 10-2013-0108066

(51) Int. Cl. H01M 10/04; H01M 2/02; H01M 2/20

(52) U.S. Cl. CPC H01M 10/0431; H01M 2/204; H01M 2/0202; H01M 2220/30
USPC 429/158; 429/94; 429/179

(57) ABSTRACT

A battery pack includes a first electrode assembly; a second electrode assembly electrically connected to the first electrode assembly; and a pouch accommodating the first electrode assembly and the second electrode assembly, wherein each of the first electrode assembly and the second electrode assembly comprises a first surface, a second surface facing the first surface, and a pair of curved surfaces connecting the first surface and the second surface, wherein the first surface of the first electrode assembly and the second surface of the second electrode assembly are oriented to face each other, and wherein the second electrode assembly is offset in a first direction such that the second electrode assembly partially overlaps with the first electrode assembly.

### CROSS-REFERENCE TO RELATED APPLICATIONS

This application claims priority to and the benefit of Korean Patent Application No. 10-2013-0108066, filed on Sep. 9, 2013, in the Korean Intellectual Property Office, the entire disclosure of which is incorporated herein by reference.

### BACKGROUND

1. Field

One or more embodiments of the present invention relate to battery packs and battery modules including the same.

2. Description of the Related Art

In general, secondary batteries are rechargeable unlike primary batteries that are not rechargeable. Depending on the type of external devices to which secondary batteries are applied, the secondary batteries may be used in the form of a single battery or in the form of a module in which a plurality of unit batteries are connected and packed into one unit.

Recently, types of electronic devices using secondary batteries have been diversified, and designs of electronic devices have become an important factor in determining the purchase of electronic devices. For example, various wearable computers using secondary batteries as a power supply source, and applications thereof have been developed and published. Also, electronic devices, such as mobile phones and laptop computers, have been designed to have curved surfaces for ergonomic purposes.

It is desirable for secondary batteries for operating electronic devices to have a large capacity to provide a sufficient use time of the electronic devices, and for the batteries to be able to change shape, for example, by modification such as bending, depending on the shape of the electronic device with which the battery is used.

### SUMMARY

One or more embodiments of the present invention include battery packs with new shapes and flexible battery modules.

Additional aspects will be set forth in part in the description which follows and, in part, will be apparent from the description.

According to one or more embodiments of the present invention, a battery pack includes a first electrode assembly; a second electrode assembly electrically connected to the first electrode assembly; and a pouch accommodating the first electrode assembly and the second electrode assembly, wherein each of the first electrode assembly and the second electrode assembly comprises a first surface, a second surface facing the first surface, and a pair of curved surfaces connecting the first surface and the second surface, wherein the first surface of the first electrode assembly and the second surface of the second electrode assembly are oriented to face each other, and wherein the second electrode assembly is offset in a first direction such that the second electrode assembly partially overlaps with the first electrode assembly.

In one embodiment, the first direction extends from a first one of the pair of curved surfaces to a second one of the pair of curved surfaces of the first or second electrode assembly. Further, in one embodiment, each of the first electrode assembly and the second electrode assembly includes a first electrode plate, a second electrode plate and a separator located between the first electrode plate and the second electrode plate, wherein the first electrode plate, the second electrode plate, and the separator are wound together, wherein the first surface, the second surface, and the pair of curved surfaces correspond to a winding surface of each of the first electrode assembly and the second electrode assembly, and wherein the first surface and the second surface are substantially flat.

A cross-sectional area of the first electrode assembly and a cross-sectional area of the second electrode assembly which are perpendicular to the winding surface may be substantially equal to each other. Additionally, an electrolyte is accommodated in the pouch, and the first electrode assembly and the second electrode assembly may both contact the electrolyte.

In various embodiments, the secondary battery further includes a first insulating layer configured to seal the first electrode assembly; and a second insulating layer configured to seal the second electrode assembly, an electrode tab attached to the first electrode assembly or the second electrode assembly, wherein the electrode tab protrudes from the pouch.

In another embodiment, a battery module includes a plurality of battery packs arranged linearly; and a lead electrode electrically connecting the battery packs, wherein each of the battery packs comprises a first electrode assembly and a second electrode assembly electrically connected to each other, wherein each of the first electrode assembly and the second electrode assembly comprises a first surface, a second surface facing the first surface, and a pair of curved surfaces connecting the first surface and the second surface, wherein the first surface of the first electrode assembly and the second surface of the second electrode assembly are oriented to face each other, and wherein the second electrode assembly is offset in a first direction such that the second electrode assembly partially overlaps with the first electrode assembly.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic perspective view of a battery module according to an embodiment of the present invention;

FIG. 2 is a schematic cross-sectional view of a battery pack included in the battery module of FIG. 1;

FIG. 3 is a schematic cross-sectional view of two adjacent battery packs included in the battery module of FIG. 1;

FIG. 4 is a schematic view illustrating a shape of the battery module of FIG. 1; and

FIG. 5 is a schematic view illustrating another shape of the battery module of FIG. 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

The present invention may include various embodiments and modifications, and exemplary embodiments are illustrated in the drawings and will be described below in detail. However, it will be understood that the present invention is not limited to the exemplary embodiments and includes all modifications, equivalents and substitutions falling within the spirit and scope of the present invention. Like reference numerals or symbols denote like elements throughout the specification and drawings.

Although terms such as “first” and “second” may be used herein to describe various elements or components, these elements or components should not be limited by these terms. These terms are only used to distinguish one element or component from another element or component.

The terms used herein are for the purpose of describing exemplary embodiments only and are not intended to be limiting of the present invention. It will be understood that terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof.

Hereinafter, embodiments of the present invention will be described in detail with reference to the accompanying drawings.

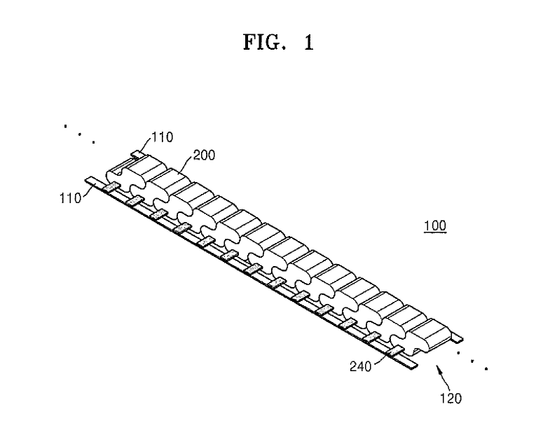

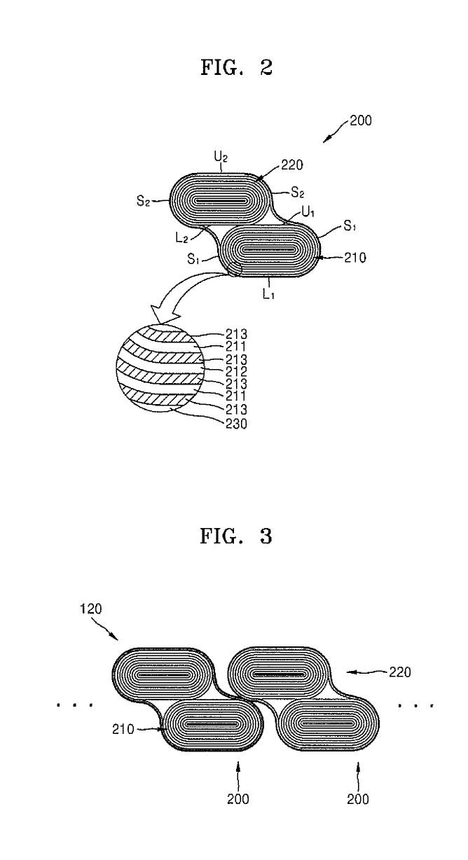

FIG. 1 is a schematic perspective view of a battery module 100 according to an embodiment of the present invention. FIG. 2 is a schematic cross-sectional view of a battery pack 200 included in the battery module 100 of FIG. 1.

Referring to FIGS. 1 and 2, the battery module 100 may include battery packs 200 and a pair of lead electrodes 110 configured to electrically connect the battery packs 200.

As illustrated in FIG. 2, each of the battery packs 200 may include a first electrode assembly 210, a second electrode assembly 220 connected electrically to the first electrode assembly 210, and a pouch 230 configured to accommodate and seal the first electrode assembly 210 and the second electrode assembly 220.

The first electrode assembly 210 and the second electrode assembly 220 may each include a first electrode plate 211, a second electrode plate 212 and a separator 213 located between the first electrode plate 211 and the second electrode plate 212, wherein the first and second electrode plates and the separator are wound together.

The first electrode plate 211 may include a first active material portion that is coated with a first active material, and a first uncoated portion that is not coated with the first active material. For example, the first active material may be a positive active material. The positive active material may be a lithium-containing transition metal oxide, such as LiCoO₂, LiNiO₂, LiMnO₂, or LiMnO₄, or a lithium chalcogenide compound.

For example, the first active material portion may be formed by coating the first active material on a portion of at least one surface of an aluminum plate, and the first uncoated portion may be the other portion of the aluminum plate that is not coated with the first active material. For example, the first uncoated portion may be located on one side of the first electrode plate 211.

The second electrode plate 212 may include a second active material portion that is coated with a second active material, and a second uncoated portion that is not coated with the second active material. For example, the second active material may be a negative active material. The negative active material may be a carbon material, such as crystalline carbon, amorphous carbon, carbon complex, or carbon fiber, a lithium metal, or a lithium alloy.

For example, the second active material portion may be formed by coating the second active material on a portion of at least one surface of a copper plate, and the second uncoated portion may be the other portion of the copper plate that is not coated with the second active material. For example the second uncoated portion may be located on one side of the second electrode plate 212.

The separator 213 prevents a short circuit between the first electrode plate 211 and the second electrode plate 212, and enables charge transfer. For example, the separator 213 may be manufactured by coating polyvinylidenefluoride-hexafluoropropylene (PVDF-HFP) copolymer on any material selected from the group consisting of polyethylene (PE), polystyrene (PS), polypropylene, and polyethylene-polypropylene copolymer.

The first electrode plate 211, the second electrode plate 212, and the separator 213 may be cylindrically wound and then pressurized such that the first electrode assembly 210 may be molded to include a first surface U₁, a second surface L₁ facing the first surface U₁, and a pair of curved surfaces S₁ connecting the first surface U₁ and the second surface L₁.

Herein, the first surface U₁, the second surface L₁, and the pair of surfaces S₁ may correspond to a winding surface of the first electrode assembly 210, and the first surface U₁ and the second surface L₁ may be substantially flat. In FIG. 2, the first surface U₁ and the second surface L₁ are illustrated separately for the convenience of description. However, the first surface U₁ and the second surface L₁ may have the same shape, and their positions may be interchanged.

Like the first electrode assembly 210, the second electrode assembly 220 may include a first electrode plate 211, a second electrode plate 212 and a separator 213 located between the first electrode plate 211 and the second electrode plate 212 that are wound together, and may include a first surface U₂ and a second surface L₂ that are flat, and a pair of curved surfaces S₂ connecting the first surface U₂ and the second surface L₂.

The second electrode assembly 220 is located on and may directly contact the first surface U₁ of the first electrode assembly 210. In detail, the first surface U₁ of the first electrode assembly 210 and the second surface L₂ of the second electrode assembly 220 may be oriented to face each other (i.e., they are generally opposite to each other). The first surface U₂ and the second surface L₂ of the second electrode assembly 220 may have the same shape, and the first surface U₁ of the first electrode assembly 210 and the first surface U₂ of the second electrode assembly 220 may be oriented to face each other.

The second electrode assembly 220 may be offset or shifted in a first direction such that the second electrode assembly 220 may be partially misaligned with the first electrode assembly 210. The first direction may be a direction facing any one of the pair of curved surfaces S₂ of the second electrode assembly 220.

Therefore, a portion of the second electrode assembly 220 may not overlap with the first electrode assembly 210, and the first electrode assembly 210 and the second electrode assembly 220 may form a substantially “S” shape or a “Z” shape on the whole.

In one embodiment, the second electrode assembly 220 is electrically connected to the first electrode assembly 210. For example, the first electrode assembly 210 and the second electrode assembly 220 may be formed separately, and the first electrode assembly 210 and the second electrode assembly 220 may be connected in series or in parallel by connecting the first electrode plate 211 included in the first electrode assembly 210 and the second electrode plate 212 or the first electrode plate 211 included in the second electrode assembly 220.

As another example, a stack may be formed by sequentially stacking the first electrode plate 211, the separator 213, and the second electrode plate 212, the first electrode assembly 210 may be formed by winding from one side of the stack toward the center of the stack, and the second electrode assembly 220 may be formed by winding from the other side of the stack toward the center of the stack.

Therefore, the first electrode assembly 210 and the second electrode assembly 220 may be electrically connected by the first electrode plate 211 and the second electrode plate 212. In this case, the first electrode assembly 210 and the second electrode assembly 220 may be connected in parallel.

A cross-sectional area of the first electrode assembly 210 and a cross-sectional area of the second electrode assembly 220, which are perpendicular to the winding surface, may be substantially equal to each other. Therefore, it is possible to prevent a voltage of the battery pack 200 from being controlled to a lower voltage of any one of the first electrode assembly 210 and the second electrode assembly 220 when the first electrode assembly 210 and the second electrode assembly 220 are connected in parallel, or to prevent a current of the battery pack 200 from being controlled to a lower current of any one of the first electrode assembly 210 and the second electrode assembly 220 when the first electrode assembly 210 and the second electrode assembly 220 are connected in series.

The pouch 230 is configured to accommodate and seal the first electrode assembly 210 and the second electrode assembly 220 and receive an electrolyte together with the first electrode assembly 210 and the second electrode assembly 220.

For example, the pouch 230 may have a three-layered structure including an insulating layer, a metal layer, and an insulating layer. For example, the metal layer may be formed of aluminum, steel, or stainless steel, and the insulating layer may be formed of casted polypropylene (CPP), polyethylene terephthalate (PET), or nylon; however, embodiments of the present invention are not limited thereto.

The electrolyte may be a liquefied electrolyte or a gelled electrolyte, and the first electrode assembly 210 and the second electrode assembly 220 may be simultaneously impregnated with the same electrolyte. In other words, the first electrode assembly 210 and the second electrode assembly 220 may both contact and share the same electrolyte.

However, embodiments of the present invention are not limited thereto, and the battery pack 200 may further include a first insulating layer configured to seal the first electrode assembly 210 and a second insulating layer configured to seal the second electrode assembly 220.

Therefore, the electrolyte may be injected into the first insulating layer and the second insulating layer, and the first electrode assembly 210 and the second electrode assembly 220 may be electrically connected to each other by electrodes protruding from the first insulating layer and the second insulating layer.

The battery pack 200 may further include an electrode tab 240 attached to the first electrode assembly 210 or the second electrode assembly 220.

As described above, since the first electrode assembly 210 and the second electrode assembly 220 are electrically connected to each other inside the pouch 230, the electrode tab 240 may be formed only at the first electrode assembly 210 or the second electrode assembly 220.

For example, when the electrode tab 240 is attached to the first electrode assembly 210, a pair of electrode tabs 240 may be attached respectively to the first uncoated portion and the second uncoated portion of the first electrode assembly 210 by ultrasonic welding.

Also, the pair of electrode tabs 240 may protrude outside the pouch 230 and may be attached to a lead electrode 110. For example, the pair of electrode tabs 240 may protrude in opposite directions from the battery pack 200.

A pair of lead electrodes 110 may be provided to electrically connect the battery packs 200 and fix the positions of the battery packs 200.

For example, the electrode tabs 240 included in each of the battery packs 200 may protrude in respective directions corresponding to respective polarities and may be connected respectively to the pair of lead electrodes 110 that are formed linearly. Therefore, since the battery packs 200 are connected in parallel, the capacity of the battery module 100 may be increased.

A connection between the lead electrode 110 and the electrode tab 240 may be made by laser welding or ultrasonic welding; however, embodiments of the present invention are not limited thereto.

The battery packs 200 connected electrically by the lead electrode 110 are aligned to form a battery pack array 120. As will be described later, the battery pack array 120 may be bent in a direction, for example, perpendicular to the first direction in which the second electrode assembly 220 is shifted. In this case, since the lead electrode 110 is also bent together with the battery pack array 120, the lead electrode 110 may be ductile such that the lead electrode 110 is not cut even when bent. For example, the lead electrode 110 may be formed of a carbon nanotube (CNT) or a metal wire; however, embodiments of the present invention are not limited thereto.

FIG. 1 illustrates that a pair of lead electrodes 110 are provided in parallel to each other; however, embodiments of the present invention are not limited thereto. The lead electrode 110 may have various patterns, depending on the methods of connecting the battery packs 200 in series, in parallel, or in series-parallel.

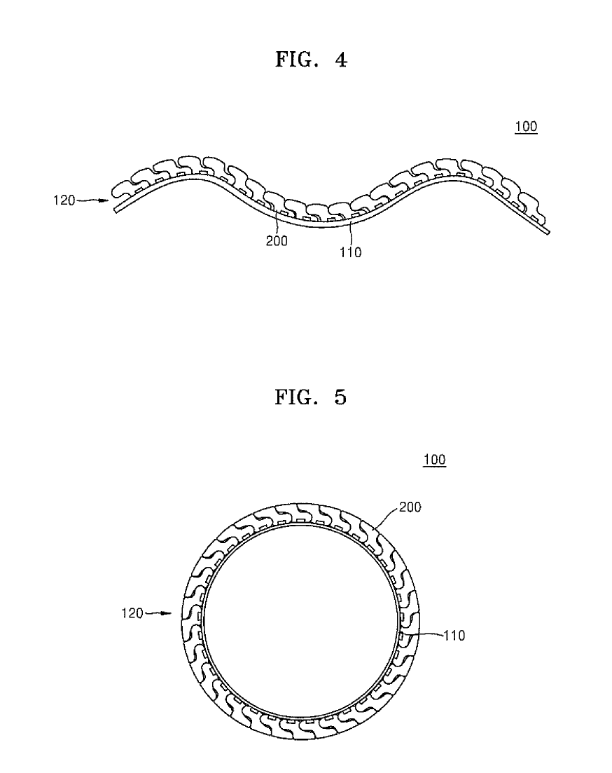

FIG. 3 is a schematic cross-sectional view of two adjacent battery packs 200 included in the battery module 100 of FIG. 1. FIG. 4 is a schematic view illustrating one shape of the battery module 100 of FIG. 1. FIG. 5 is a schematic view illustrating another shape of the battery module 100 of FIG. 1. For the convenience of description, FIG. 3 illustrates two battery packs 200 that are adjacent to each other in the battery pack array 120.

Referring to FIG. 3, when two battery packs 200 are located adjacent to each other, the second electrode assembly 220 of the other of the adjacent battery packs 200 is located on the first electrode assembly 210 of one of the adjacent battery packs 200.

Since the positions of the battery packs 200 may be fixed by the lead electrode 110 (see FIG. 1) that is ductile, the adjacent battery packs 200 may not be attached to each other. Therefore, when a force is applied to the battery pack array 120 in a second direction perpendicular to the first direction in which the second electrode assembly 220 is shifted, the battery pack array 120 may be bent by the force.

For example, when the first direction is parallel to a ground surface, the battery pack array 120 may be bent in a vertical direction.

In order to fix the positions of the battery packs 200 more securely, the battery module 100 may further include a wrapping member that covers the lead electrode 110 (see FIG. 1) and the battery pack array 120. The wrapping member may be, for example, a shrinking tube, but is not limited thereto.

FIG. 4 illustrates one shape of the battery module 100. In detail, FIG. 4 illustrates that the battery module 100 is bent repeatedly in the vertical direction. Also, FIG. 5 illustrates that the battery module 100 is bent only in an upward direction or a downward direction to have a circular shape on the whole. In this case, the pair of lead electrodes 110 may protrude outside and may be connected to an external electronic device to which the battery module 100 is attached.

Therefore, since the shape of the battery module 100 may be varied according to the shape of an electronic device, an internal space of the electronic device may be efficiently used.

As described above, according to the one or more of the above embodiments of the present invention, the shape of the battery module may be varied according to the shape of the electronic device.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A battery pack comprising:
a first electrode assembly;
a second electrode assembly electrically connected to the first electrode assembly; and
a pouch accommodating the first electrode assembly and the second electrode assembly, wherein each of the first electrode assembly and the second electrode assembly comprises a first surface, a second surface facing the first surface, and a pair of curved surfaces connecting the first surface and the second surface,
wherein the first surface of the first electrode assembly and the second surface of the second electrode assembly are oriented to face each other, and
wherein the second electrode assembly is offset in a first direction such that the second electrode assembly partially overlaps with the first electrode assembly.

2. The battery pack of claim 1, wherein the first direction extends from a first one of the pair of curved surfaces to a second one of the pair of curved surfaces of the first or second electrode assembly.

3. The battery pack of claim 1, wherein each of the first electrode assembly and the second electrode assembly comprises a first electrode plate, a second electrode plate and a separator located between the first electrode plate and the second electrode plate, wherein the first electrode plate, the second electrode plate, and the separator are wound together,
wherein the first surface, the second surface, and the pair of curved surfaces correspond to a winding surface of each of the first electrode assembly and the second electrode assembly, and
wherein the first surface and the second surface are substantially flat.

4. The battery pack of claim 3, wherein a cross-sectional area of the first electrode assembly and a cross-sectional area of the second electrode assembly which are perpendicular to the winding surface are substantially equal to each other.

5. The battery pack of claim 1, wherein an electrolyte is accommodated in the pouch, and wherein the first electrode assembly and the second electrode assembly both contact the electrolyte.

6. The battery pack of claim 1, further comprising:
a first insulating layer configured to seal the first electrode assembly; and
a second insulating layer configured to seal the second electrode assembly.

7. The battery pack of claim 1, further comprising an electrode tab attached to the first electrode assembly or the second electrode assembly.

8. The battery pack of claim 7, wherein the electrode tab protrudes from the pouch.

9. A battery module comprising:
a plurality of battery packs arranged linearly; and
a lead electrode electrically connecting the battery packs,
wherein each of the battery packs comprises a first electrode assembly and a second electrode assembly electrically connected to each other,
wherein each of the first electrode assembly and the second electrode assembly comprises a first surface, a second surface facing the first surface, and a pair of curved surfaces connecting the first surface and the second surface,
wherein the first surface of the first electrode assembly and the second surface of the second electrode assembly are oriented to face each other, and
wherein the second electrode assembly is offset in a first direction such that the second electrode assembly partially overlaps with the first electrode assembly.

10. The battery module of claim 9, wherein each of the battery packs further comprises a pouch accommodating the first electrode assembly and the second electrode assembly.

11. The battery module of claim 10, wherein the first direction is a direction extending from a first one of the pair of curved surfaces to a second one of the pair of curved surfaces of the first or second electrode assembly.

12. The battery module of claim 11, wherein each of the first electrode assembly and the second electrode assembly comprises a first electrode plate, a second electrode plate and a separator located between the first electrode plate and the second electrode plate, wherein the first electrode plate, the second electrode plate, and the separator are wound together;
wherein the first surface, the second surface, and the pair of curved surfaces correspond to a winding surface of each of the first electrode assembly and the second electrode assembly, and
wherein the first surface and the second surface are substantially flat.

13. The battery module of claim 12, wherein the first electrode assembly is located adjacent to the second electrode assembly.

14. The battery module of claim 13, wherein the battery packs form a battery pack array, and wherein the battery pack array is bent to extend in a direction perpendicular to the first direction.

15. The battery module of claim 12, wherein a cross-sectional area of the first electrode assembly and a cross-sectional area of the second electrode assembly which are perpendicular to the winding surface are substantially equal to each other.

16. The battery module of claim 10, wherein an electrolyte is accommodated in the pouch, and wherein the first electrode assembly and the second electrode assembly both contact the electrolyte.

17. The battery module of claim 10, further comprising:
a first insulating layer configured to seal the first electrode assembly; and
a second insulating layer configured to seal the second electrode assembly.

18. The battery module of claim 10, wherein each of the battery packs further comprises an electrode tab attached to the first electrode assembly or the second electrode assembly.

19. The battery module of claim 18, wherein the electrode tab is connected to the lead electrode.

20. The battery module of claim 19, wherein the lead electrode is ductile.
